(19) United States
(12) Patent Application Publication
(10) Pub. No.: US 2009/0116699 A1
(43) Pub. Date: May 7, 2009

(54) Temperature stabilization of biometric devices

(76) Inventors: Joseph J. Turek, Palmer, MA (US); Katrina S. Champagne, Palmer, MA (US); Robert John Encarnacion, San Jose, CA (US)

Correspondence Address: Ashok Tankha;Of Counsel, Lipton, Weinberger & Husick, 36 Greenleigh Drive, Sewell, NJ, 08080, US

(21) Appl. No.: 11/982,647

(22) Filed: Nov. 2, 2007

(51) Int. Cl. G06K 9/20; F24J 3/08

(52) U.S. Cl. 382/115; 165/45; 356/71

(57) ABSTRACT

The system disclosed herein increases the acceptance rate of capture and authentication of biometric data by a biometric device. The biometric device's acceptance rate is improved by maintaining the operating temperature of biometric device within a preset temperature range. The biometric device is housed in a thermal enclosure. A geothermal system is used for maintaining the operating temperature of the biometric device within the preset temperature range by regulating the temperature of the air within the thermal enclosure. A temperature sensor is provided for determining the operating temperature of the biometric device. A control unit controls the operation of the geothermal system based on the operating temperature information provided by the temperature sensor. Further, the system disclosed herein is used for temperature stabilization of electronic devices whose operating temperature needs to be maintained within a preset temperature range for optimal operation.

### BACKGROUND

This invention in general relates to biometric devices used for the identification and authorization of an individual. More particularly, this invention relates to temperature stabilization of a biometric device for improving the biometric device's performance.

Biometric devices accomplish identification of individuals based on unique biological characteristics. The biometric techniques for human identification and authorization typically employ fingerprint scanning, iris recognition, hand geometry mapping, palm scanning, etc. In a typical automated fingerprint identification technique, an individual's fingerprint is captured as an image using a fingerprint reader. The captured image is then electronically digitized. The digitized data contains information about fingerprint characteristics such as ridge endings, points of ridge bifurcation, the core of a whorl, i.e. fingerprint minutiae, etc. The digitized data may then be compared with stored fingerprint templates that have been previously obtained. If a match between the digitized data and previously stored fingerprint template is detected within a predetermined level of accuracy, the individual is identified and a predetermined action is performed.

Biometric devices may be one of a contact type and a non-contact type. In case of a contact type biometric device, a biometric object such as a finger, a palm, etc., is placed on the image capturing surface of the biometric device. There are several factors affecting the accurate capturing of biometric data by a contact type biometric device. The condition of the fingertip and the fingerprint profile itself may vary depending on the properties of the skin and the environmental conditions. For example in cold temperature conditions, the blood circulation in the extremities such as fingers is reduced to maintain the body temperature. Conversely, in warmer temperature, the blood flow is increased. The hygienic conditions of the hand and more particularly that of the fingertip to be imaged are also factors for possible interference in properly imaging a fingerprint. There are two types of errors associated with fingerprint identification; false accept error and false reject error.

A false accept error occurs when there is an apparent similarity between fingerprints of two individuals. A biometric device such as fingerprint reader captures fingerprint data incorrectly when it is operated in dusty conditions. Owing to the incorrect capture of fingerprint data, an individual's identity may be falsely recognized and eventually authenticated. A false reject error arises when an individual is not identified by the biometric device even though the individual is an authorized user registered with the scanning system. A false reject error occurs when there is a faulty capture of fingerprint data and consequently access rights are denied to an authorized user. The faulty capture of a certain fingerprint data contradicts with previously captured correct data of the same fingerprint and has undesirable effects.

The above mentioned errors in fingerprint verification are usually caused by parameters of a non-biometric nature such as temperature. A biometric device may be prone to erroneous capture of biometric data due to water or moisture deposition on the image capturing surface. Further, biometric devices function optimally in a certain preset temperature range. Capturing biometric characteristics or features, for example, finger prints, handprints, iris scans, etc., when the biometric device is operating outside the optimum temperature range may increase the probability of erroneous operation.

Oil and gas exploration facilities and pipelines are typically found in remote locations such as deserts and tundra regions. A secured access to such installations requires personnel identification and authentication. Biometric authentication devices used in these remote locations require significant energy for temperature regulation under extreme temperature conditions. Further, in these remote locations conventional energy sources such as electrical energy may not be available for heating and cooling operations. Hence, there is a need for an energy-efficient method and system for temperature regulation of biometric devices operating in regions with extreme temperatures.

### SUMMARY OF THE INVENTION

The system disclosed herein, addresses and provides solutions to the above mentioned needs. The system disclosed herein improves the acceptance rate of biometric data by minimizing false reject errors and false accept errors in a biometric device. The false reject and false accept errors are minimized by maintaining the operating temperature of the biometric device within an optimal preset temperature range. The biometric device is housed in a thermal enclosure to regulate the temperature of the biometric device. A temperature sensor is provided on the image capturing surface of the biometric device to measure the operating temperature of the biometric device. The temperature of the air within the thermal enclosure is regulated according to the changes in the operating temperature of the biometric device. The regulation of the temperature of the air within the thermal enclosure causes the biometric device to operate within the preset temperature range. A thermal resource is used to maintain the operating temperature of the biometric device within a preset temperature range. The thermal resource mentioned above is an external thermal resource, an internal thermal resource, or a combination thereof.

In desert and tundra conditions, the temperature difference between the earth's interior and the earth's surface is significant. The temperature of the geothermal fluids such as air and water available beneath the earth's surface is significantly higher or lower than the ambient temperature above the earth's surface. Such geothermal fluids serve as unconventional geothermal energy sources for temperature regulation purposes. These geothermal fluids is used an external thermal resource to maintain the operating temperature of the biometric device used in remote desert and tundra regions.

A geothermal system comprising a heat pump and a geothermal circulating system is used for regulating the temperature of the air within the thermal enclosure housing the biometric device. The geothermal system is used to regulate the temperature of the air within the thermal enclosure by a two stage heat transfer process. The first stage of the heat transfer process involves heat transfer between a refrigerant and the geothermal fluid in a first heat exchanger of the heat pump. The second stage of the heat transfer process involves heat transfer between the refrigerant and the air within the thermal enclosure in a second heat exchanger of the heat pump.

The heat pump of the geothermal system comprises a first heat exchanger, a second heat exchanger, a compressor, a reversible valve, a first expansion valve, a second expansion valve, and refrigerant circulating tubes. The geothermal circulating system of the geothermal system is used for extracting the geothermal fluid from the earth's interior. When the operating temperature of the biometric device drops below the preset temperature range, the temperature of the air within the thermal enclosure is increased by operating the heat pump. A refrigerant circulating through the refrigerant circulating tubes, transfers heat energy from the warm geothermal fluid to the cooler air within the thermal enclosure.

When the operating temperature of the biometric device increases above the preset temperature range, the temperature of the air within the thermal enclosure is lowered by the heat pump. The refrigerant circulating through the refrigerant circulating tubes transfers the heat energy from the warm air within the thermal enclosure to the cooler geothermal fluid.

Electronic components such as resistors, capacitors, operational amplifiers, batteries, etc. that generate heat energy in the biometric device are used as an internal thermal resource. The heat generated by the electronic components is transferred to the biometric device, to increase the operating temperature of the biometric device. Such a heat transfer is useful when the operating temperature of the biometric device falls below the preset temperature range. Further, moisture deposition on the image capturing surface of the biometric device is prevented by operating the biometric device in a higher preset range of temperature.

### BRIEF DESCRIPTION OF THE DRAWINGS

FIG. 1 illustrates a system for temperature stabilization of a biometric device.

FIG. 2 illustrates the system for increasing the temperature of the biometric device.

FIG. 3 illustrates the system for decreasing the temperature of the biometric device.

FIG. 4 illustrates one embodiment of the system for temperature stabilization of the biometric device.

FIG. 5 illustrates another embodiment of the system for temperature stabilization of the biometric device.

FIG. 6 illustrates a process of temperature stabilization of the biometric device.

### DETAILED DESCRIPTION OF THE DRAWINGS

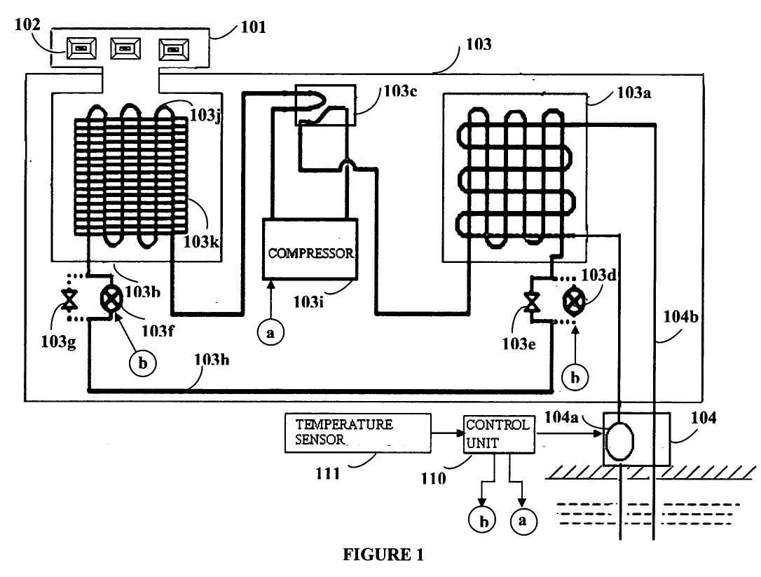

FIG. 1 illustrates a system for temperature stabilization of a biometric device 102. The biometric device 102 is housed in a thermal enclosure 101. The temperature and humidity requirements for the optimal operation of the biometric device are fulfilled by maintaining the temperature and humidity condition of the air within the thermal enclosure 101. The temperature of the air within the thermal enclosure 101 is regulated by a geothermal system.

The geothermal system comprises a heat pump 103 and a geothermal circulating system 104. The heat pump 103 is used for transferring heat between geothermal fluids and the air within the thermal enclosure 101. The geothermal fluids may be one of air and ground water present beneath the earth's surface. The temperature difference between the geothermal fluids and the air within the thermal enclosure 101 is sufficient for a heat transfer to take place between the geothermal fluids and the air within the thermal enclosure 101. The heat pump 103 comprises a first heat exchanger 103a, a second heat exchanger 103b, a reversible valve 103c, a first expansion valve 103d, a first bypass valve 103e, a second expansion valve 103f, a second bypass valve 103g, refrigerant circulating tubes 103h, and a compressor 103i. The geothermal circulating system 104 comprises a geothermal fluid pump 104a and circulating pipes 104b. A control unit 110 dynamically controls the operation of the compressor 103i, the first expansion valve 103d, the second expansion valve 103f, and the geothermal fluid pump 104a. The first and second expansion valves, 103d and 103f are similar in construction and method of operation.

The geothermal system is used to regulate the temperature of the air within the thermal enclosure 101 by a two stage heat transfer process. The first stage of the heat transfer process involves heat transfer in the first heat exchanger 103a between a refrigerant and a geothermal resource. The second stage of the heat transfer process involves heat transfer in the second heat exchanger 103b between the refrigerant and the air within the thermal enclosure 101.

The control unit 110 has a memory means that stores the temperature and humidity information about the biometric device and the air within the thermal enclosure 101. A maximum and a minimum admissible value of the biometric device's operating temperature may be preset and stored in the memory means of the control unit 110. The stored maximum and minimum temperature values define a preset temperature range for the optimal operation of the biometric device 102. A temperature sensor 111, provided in proximity to the biometric device's image capturing surface, measures the operating temperature of the biometric device 102. The temperature sensor 111 signals the control unit 110 about the operating temperature of the biometric device 102. The operating temperature of the biometric device 102 may be higher than the maximum value or lower than the minimum value of the preset temperature range.

The control unit 110 determines the temperature difference between the operating temperature and preset temperature range of the biometric device 102. The control unit 110 initiates control operations of the compressor 103i, the first expansion valve 103d, the second expansion valve 103f and the geothermal fluid pump 104a such that the temperature of the air within the thermal enclosure 101 varies. The controlled variation of the temperature of the air within the thermal enclosure 101 causes the operating temperature of the biometric device 102 to fall within the preset temperature range.

In one embodiment of the invention, the thermal enclosure 101 may house a plurality of biometric devices 102. A plurality of temperature sensors 111 in contact with the image capturing surface of each of the plurality of the biometric devices 102, are provided. The control unit 110 receives information on the operating temperatures of the biometric devices 102 from the plurality of temperature sensors 111. The temperature of the air within the thermal enclosure 101 may be regulated such that moisture formation on any of the plurality of biometric devices 102 is prevented. The temperature of the air within the thermal enclosure 101 is maintained at a value that is optimal for the operation of the plurality of the biometric devices 102 with minimal errors in data acceptance.

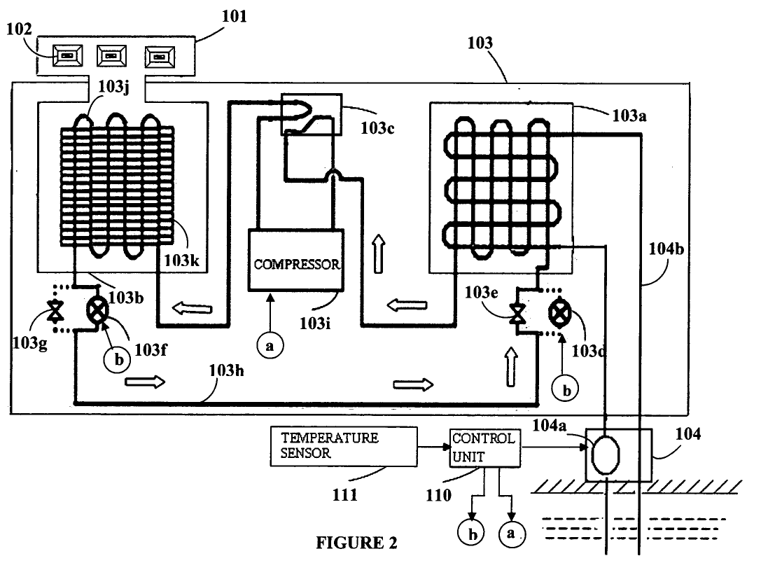

FIG. 2 illustrates the system for increasing the temperature of the biometric device 102 housed in the thermal enclosure 101. A temperature sensor 111 measures the operating temperature of the biometric device 102. The temperature sensor 111 transmits the operating temperature information of the biometric device 102 to the control unit 110. If there is a decrease in the operating temperature of the biometric device 102, the control unit 110 detects the decrease in the operating temperature of the biometric device 102. The control unit 110 performs control actions of the compressor 103i, the first 103d and the second expansion valves 103f, and the geothermal fluid pump 104a. The control actions are performed by the control unit 110 such that the operating temperature of the biometric device 102 increases and is within the preset temperature range.

The control unit 110 performs a first control action of electromechanically operating the geothermal fluid pump 104a. The geothermal fluid pump 104a extracts geothermal fluid from the earth's interior. The amount of heat energy to be transferred to the air within the thermal enclosure 101 to increase the operating temperature of the biometric device 102 is automatically determined by the control unit 110. The control unit 110 considers the temperature difference between the air within the thermal enclosure 101 and the operating temperature of the biometric device 102 in the process of establishing the amount of heat energy to be transferred. The amount of heat energy to be transferred to the air within the thermal enclosure 101 is a direct measure for the quantity of geothermal fluid required. Hence, the control unit 110 controls the operation of the geothermal fluid pump 104a such that a predetermined quantity of geothermal fluid is circulated in the circulating pipes 104b.

A refrigerant is circulated through the refrigerant circulating tubes 103h. The geothermal fluid is at a higher temperature than the refrigerant. Hence, the temperature of the refrigerant is raised as the refrigerant is in heat exchange relation with the geothermal fluid in the first heat exchanger 103a. The refrigerant after passing through the first heat exchanger 103a is passed through the compressor 103i. The control unit 110 performs a control action on the compressor 103i to obtain a controlled rate and degree of refrigerant compression. The compressor 103i compresses the refrigerant further raising the refrigerant's temperature. The reversible valve 103c then directs the compressed refrigerant to the second heat exchanger 103b. The second heat exchanger 103b comprises a duct 103j with heat transfer fins 103k and a fan.

Cool air within the thermal enclosure 101 is circulated over the heat transfer fins 103k by the fan. Heat transfer occurs between the cool air and the compressed refrigerant flowing through the duct 103j. During the heat transfer process, the compressed refrigerant loses heat energy to the air within the thermal enclosure 101. The partially cooled refrigerant flows through the second expansion valve 103f and cools further. The rate and degree of cooling of the refrigerant in the second expansion valve 103f is controlled by the control unit 110. The liquid refrigerant enters the first heat exchanger 103a through the first bypass valve 103e and the heating cycle repeats as described above.

The second expansion valve 103f is electronically controlled by the control unit 110. The control unit 110 controls the operation of the second expansion valve 103f based on the temperature difference between the preset temperature range and current operating temperature of the biometric device 102. For example, if more heat energy has been transferred to the refrigerant by the air within the thermal enclosure 101, the control unit 110 electrically signals the second expansion valve 103f to increase the rate and degree of expansion of the refrigerant. Thus, a faster rate of cooling of the refrigerant is achieved by increasing the expansion rate of the refrigerant.

The heat transfer process between the compressed refrigerant and the air within the thermal enclosure 101 causes an increase in the temperature of air within the thermal enclosure 101. The high temperature air within the thermal enclosure 101 increases the operating temperature of the biometric device 102 as air circulates around the region occupied by the biometric device 102. Thus, the operating temperature of the biometric device 102 is maintained within the preset temperature range.

In addition to the geothermal fluid that is an external thermal resource, an internal thermal resource may also be used for heating the air within the thermal enclosure 101. The internal thermal resource is used to keep the image capturing surface of the biometric device 102 free from moisture. The biometric device 102 operates erroneously if moisture is present on the image capturing surface of the biometric device 102. The electronic components such as resistors, capacitors, operational amplifiers, battery, etc. are present in proximity to the image capturing surface. These electronic components generate heat while the biometric device 102 is operational. The heat generated by these electronic components is channeled through micro heat pipes to a radiant heat plate around the circumference of the image capturing surface of the biometric device 102. The heat circulated around the image capturing surface of the biometric device 102 renders the image capturing surface dry and moisture-free.

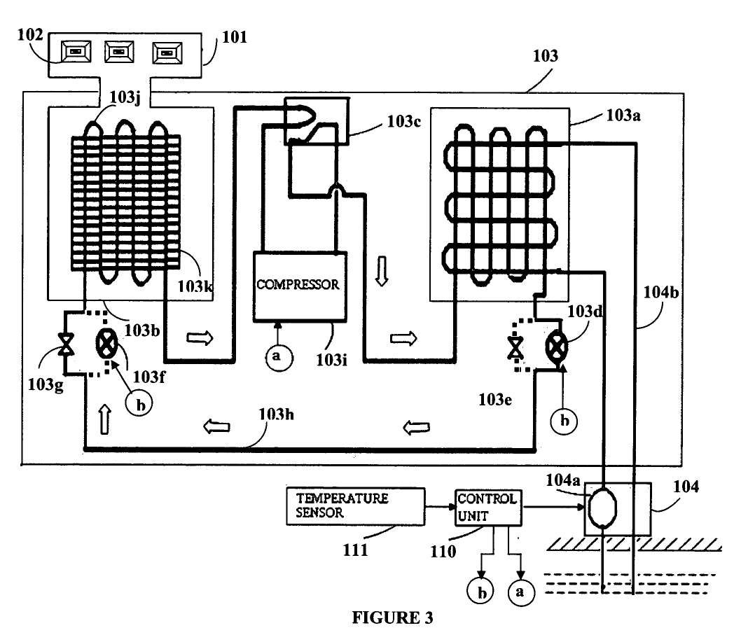

FIG. 3 illustrates the system for decreasing the temperature of the biometric device 102 housed in the thermal enclosure 101. The temperature sensor 111 transmits the operating temperature information of the biometric device 102 to the control unit 110. The control unit 110 detects if there is an increase in the operating temperature of the biometric device 102 higher than the preset temperature range.

A refrigerant is circulated through the refrigerant circulating tubes 103h. The compressor 103i compresses the refrigerant and thus increases the refrigerant's temperature. The control unit 110 performs a control action on the compressor 103i to obtain a controlled rate and degree of refrigerant compression. The reversible valve 103c reverses the direction of flow of the refrigerant as illustrated in FIG. 3. The high temperature and compressed refrigerant is delivered to the first heat exchanger 103a by the reversible valve 103c. The high temperature and compressed refrigerant is in heat exchange relation with the cooler geothermal fluid in the first heat exchanger 103a. The high temperature and compressed refrigerant loses heat energy to the geothermal fluid and the temperature of the refrigerant is reduces. The refrigerant is further cooled due to the refrigerant's expansion in the first expansion valve 103d. The rate and degree of cooling of the refrigerant is varied by controlling the refrigerant's expansion rate in the first expansion valve 103d. The control unit 110 controls the operation of the first expansion valve 103d.

The cooled refrigerant is passed to the second heat exchanger 103b through the second bypass valve 103g. The warm air within the thermal enclosure 101 is circulated over the heat transfer fins 103k of the duct 103j by the fan. The cooled refrigerant accepts the heat energy from the warm air within the thermal enclosure 101. The temperature of the refrigerant is raised due to heat transfer from the air within the thermal enclosure 101. The higher temperature refrigerant is the passed to the compressor 103i and as explained before the cooling cycle is repeated.

The heat transfer from the warm air within the thermal enclosure 101 and the cooled refrigerant causes a decrease in the temperature of the air within the thermal enclosure 101. The cool air within the thermal enclosure 101 decreases the operating temperature of the biometric device 102, as the air circulates around the region occupied by the biometric device 102. Thus, the operating temperature of the biometric device 102 is maintained within the preset temperature range.

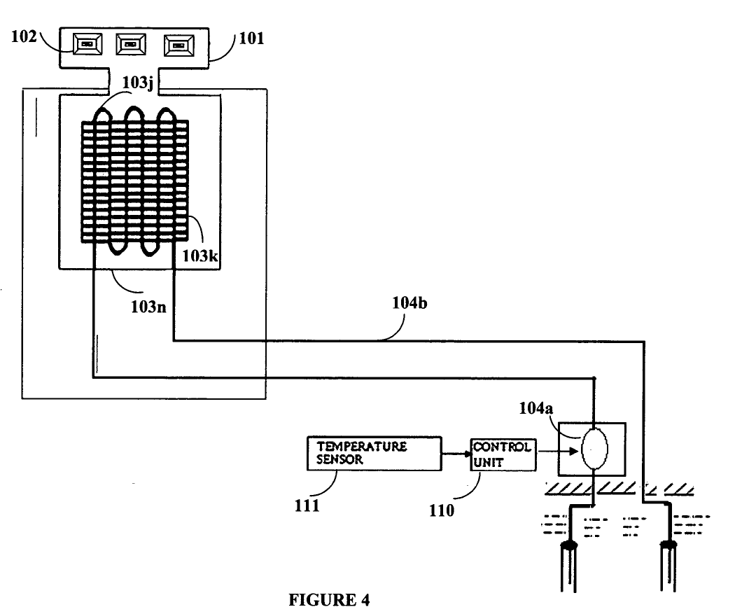

FIG. 4 illustrates one embodiment of the system for temperature stabilization of the biometric device 102 housed in a thermal enclosure 101. The system of FIG. 4 for temperature stabilization comprises a single heat exchanger 103n. The first heat exchanger 103a as illustrated in FIG. 1 is absent in the system of FIG. 4. Further, in the system of FIG. 4, a refrigerant is not used as a medium to transfer heat energy between the air circulating within the thermal enclosure 101 and the geothermal fluids. The system of FIG. 4 extracts the geothermal fluid from the earth's interior for heat transfer between the geothermal fluid and the air within the thermal enclosure 101. The geothermal fluid is circulated through the circulating pipes 104b by the operation of the geothermal fluid pump 104a. The circulating geothermal fluid passes through the single heat exchanger 103n and is in heat exchange relationship with the air that is circulated over the heat transfer fins 103k. The control unit 110 controls the operation of the geothermal fluid pump 104a such that a predetermined amount of geothermal fluid is circulated in the circulating pipes 104b. The circulating pipes 104b are sunk into the earth. The temperature of the air within the thermal enclosure 101 may be increased or decreased by heat transfer between the air within the thermal enclosure 101 and the circulating geothermal fluid, thereby regulating the temperature of the biometric device 102.

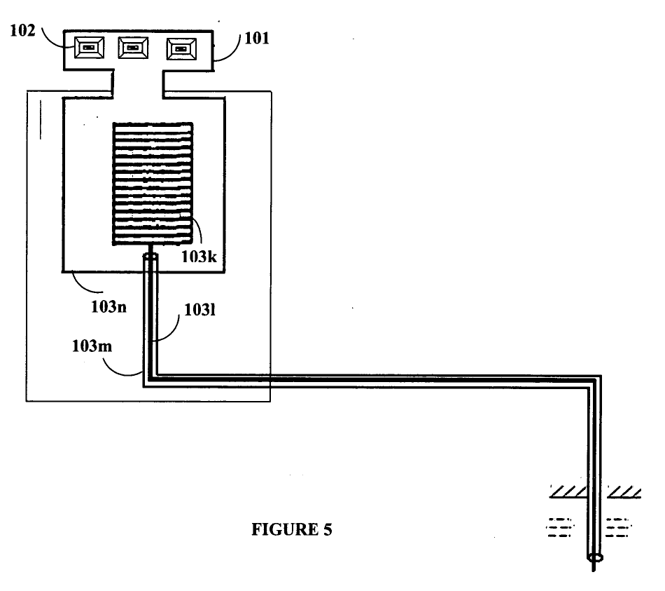

FIG. 5 illustrates another embodiment of the system for temperature stabilization of the biometric device 102 housed in a thermal enclosure 101. A thermal conductor 103l is used to transfer heat energy between the geothermal fluid and the air within the thermal enclosure 101. The thermal conductor 103l may be composed of a metal, an alloy, a composite material, or other heat conducting materials with high thermal conductivity. In the system of FIG. 5, the geothermal fluid is not circulated for through heat exchangers for heat transfer. One end of the thermal conductor 103l is connected to the heat transfer fins 103k and the other end of the thermal conductor 103l is immersed into the geothermal fluid beneath the earth's surface. The thermal conductor 103l may be insulated with an insulating material 103m to prevent heat loss due to leakage of heat energy between the thermal conductor 103l and the surroundings.

The air within the thermal enclosure 101 is maintained at a constant temperature by a bi-directional heat transfer between the geothermal fluid and the air within the thermal enclosure 101 through thermal conduction. If the operating temperature of the biometric device 102 is high during hot conditions, then the temperature of the air within the thermal enclosure 101 increases, thereby heating up the heat transfer fins 103k. Subsequently, the portion of the thermal conductor 103l connected to the heat transfer fins 103k heats up. Due to a temperature gradient that exists between the two ends of the thermal conductor 103l, heat energy is transferred from the hotter heat transfer fins 103k to the cooler geothermal fluid via thermal conduction. As the temperature of the air within the thermal enclosure 101 decreases due to the heat transfer process, the operating temperature of the biometric device 102 also reduces.

If the operating temperature of the biometric device 102 is low during cold conditions, the thermal conductor 103l transfers the heat energy from the warmer geothermal fluid to the cooler air within the thermal enclosure 101 via the heat transfer fins 103k. The temperature of the air within the thermal enclosure 101 increases due to the heat transfer. Subsequently, the operating temperature of the biometric device 102 also increases.

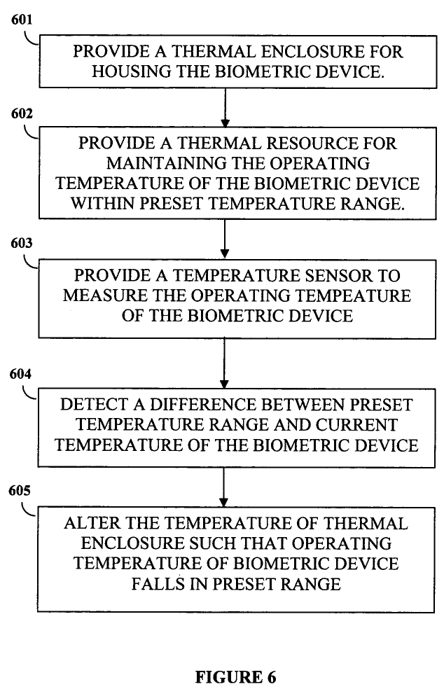

FIG. 6 illustrates a process of temperature stabilization of the biometric device 102. A thermal enclosure 101 is provided 601 to house the biometric device 102. A geothermal system that uses a geothermal resource for the purpose of maintaining the operating temperature of the biometric device 102 within a preset temperature range is provided 602. A temperature sensor 111 is provided 603 to measure the operating temperature of the biometric device 102. The temperature difference between the current operating temperature of the biometric device 102 and the preset temperature range is detected 604 by the control unit 110. The temperature of the air within the thermal enclosure 101 is altered 605 such that the operating temperature of the biometric device 102 is maintained within the preset temperature range.

The operation of the control unit 110 described in the above description may be one of an electronic, a mechanical, a computer program controlled, or any combination thereof. The control unit 110 may be of a hardwired logic device or a programmable logic device.

Although the system and method disclosed herein is described with reference to the temperature stabilization of the biometric device 102, the disclosed system and method along with all their embodiments may be utilized for temperature stabilization of other electronic devices, not necessarily limited to a biometric device 102, that require to be maintained within a preset temperature range for their optimal operation. The disclosed system and method along with their embodiments may be used to maintain the operating temperature of the electronic devices within the preset temperature range as described above in the detailed descriptions of FIG. 1 to FIG. 6.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A system for increasing acceptance rate in capture and authentication of biometric data by a biometric device by maintaining operating temperature of said biometric device within a preset temperature range, comprising:
a thermal enclosure for housing the biometric device;
a temperature sensor for determining said operating temperature of the biometric device;
a geothermal system in proximity to the biometric device for maintaining the operating temperature of the biometric device within said preset temperature range; and
a control unit for automatically controlling operation of said geothermal system.

2. The system of claim 1, wherein said geothermal system comprises a geothermal circulation system for circulating geothermal fluids.

3. The system of claim 1, wherein said geothermal system further comprises a heat pump for transferring heat energy between the geothermal fluids and the biometric device.

4. The system of claim 2, wherein said geothermal fluids is one of air and water obtained from beneath the earth's surface.

5. The system of claim 1 further comprising an internal thermal resource, wherein said internal thermal resource is a plurality of heat generating electronics components of the biometric device.

6. The system of claim 5, wherein said plurality of electronics components comprises operational amplifiers, resistors, logic gates, transistors, capacitors, and batteries.

7. The system of claim 5, wherein heat generated by said internal thermal resource is channeled to a radiant heat plate located on the biometric device.

8. The system of claim 1, wherein said geothermal system comprises a thermal conductor to transfer the heat energy between the geothermal fluids and the biometric device.

9. A system for maintaining operating temperature of an electronic device within a preset temperature range, comprising:
a thermal enclosure for housing said electronic device; a temperature sensor for determining said operating temperature of the electronic device;
a geothermal system in proximity to the electronic device for transferring heat energy between the electronic device and a geothermal fluid; and
a control unit for automatically controlling operation of said thermal resource.

10. The system of claim 9, wherein said geothermal system comprises a geothermal circulation system for circulating said geothermal fluid.

11. The system of claim 9, wherein said geothermal system further comprises a heat pump for transferring the heat energy between the geothermal fluid and the electronic device.

12. The system of claim 10, wherein said geothermal fluid is one of air and water obtained from beneath the earth's surface.

13. The system of claim 9, wherein said geothermal system comprises a thermal conductor to transfer the heat energy between the geothermal fluid and the electronic device.
